(19) United States
(12) Patent Application Publication
(10) Pub. No.: US 2026/0166969 A1
(43) Pub. Date: Jun. 18, 2026

(54) Air Conditioner and Motor Vehicle With Such an Air Conditioner

(71) Applicant: MAHLE International GmbH, Stuttgart (DE)

(72) Inventors: Lukas Pobitzer, Weinstadt (DE); Matthias Schall, Ostfildern-Ruit (DE); Kerstin Wochele, Friolzheim (DE)

(21) Appl. No.: 19/416,784

(22) Filed: Dec. 11, 2025

(30) Foreign Application Priority Data
Dec. 13, 2024 (DE) 102024137687.2

(51) Int. Cl. B60H 3/02; F24F 3/14; F24F 13/14

(52) U.S. Cl. CPC B60H 3/024; F24F 3/1411; F24F 13/14; F24F 2003/144

(57) ABSTRACT

An air conditioner for a motor vehicle that has a dehumidifier in or on a flow channel, which contains a hygroscopic element is provided. The air conditioner includes a
the flow channel that is divided into two sub-channels downstream of the dehumidifier
there is a shutter assembly with a shutter that can be pivoted between at least a first and second position, and
when the shutter is in the first position, at least most of the air flowing through the dehumidifier is conducted into the first sub-channel, and in the second position, at least most of the air flowing through the dehumidifier is conducted into the second sub-channel.

### CROSS-REFERENCE TO RELATED APPLICATIONS

This application claims priority from German Patent Application No. 102024137687.2, filed on Dec. 13, 2024, the entirety of which is hereby incorporated by reference herein.

The present invention relates to an air conditioner for a motor vehicle. The invention also relates to a motor vehicle that has such an air conditioner.

Particularly for electric vehicles, a very efficient air conditioner is needed to avoid unnecessarily limiting their travel range. To be able to reduce the amount of energy used for heating the vehicle in winter, the aim is to make maximum use of air that has already been heated. People or other objects contribute significantly to the humidity in the air circulating in a passenger compartment. When it is cold outside, particularly in winter, this contributes substantially the amount of condensation that may accumulate on the windows. For this reason, a significantly higher portion of fresh air has been used in the prior art to prevent this.

The disadvantage with this is that it consumes more electricity, because this fresh air must first be heated, in particular when it is cold outside.

The problem addressed by the present invention is to create an air conditioner for a motor vehicle with which the problems from the prior art can be overcome.

This problem is solved with the invention by the subject matter of the independent Numbered Paragraph 1. Advantageous embodiments are the subject matter of the dependent Numbered Paragraphs.

The present invention is based on the concept of creating an efficient means of air conditioning a motor vehicle, e.g. an electric vehicle, even when it is cold outside, with which it is possible to operate the air conditioner as long as possible in the recirculating mode by using a dehumidifier, which adsorbs the humidity generated by people in the passenger compartment and discharges it into the environment. The air conditioner for a vehicle obtained with the invention therefore has such a dehumidifier in an airflow channel that has a hygroscopic element that can be heated, e.g. a ceramic PTC element with a hygroscopic coating on the outside. The airflow channel is divided into two sub-channels downstream of this dehumidifier. Electricity is supplied to the element in order to heat it. There is also a shutter assembly with a shutter that conducts at least most of the air flowing through the dehumidifier into the first sub-channel in one position, and at least most of the air flowing through the dehumidifier into the second sub-channel in the second position. “At least most” can also mean “all” in this context. This makes it possible to operate the air conditioner obtained with the invention in the recirculating mode when the shutter is in the first position, such that the air from the passenger compartment flows through the air conditioner and the dehumidifier, which is not heated in this case, and then through the first sub-channel back into the passenger compartment. Humidity is accommodated by the hygroscopic material or coating on the element in the dehumidifier, removing it from the air supply to the passenger compartment. Once a moisture sensor determines that the hygroscopic element can no longer accommodate any moisture, the shutter is pivoted to its second position, conducting the air flowing through the dehumidifier into the second sub-channel, which leads to the exterior. In this position, electricity is supplied to the dehumidifier, thus heating it, switching it to the desorption state, in which the moisture adsorbed in the hygroscopic element is discharged in the second airflow into the second sub-channel, and thus the exterior. This dehumidifier forms a simple means of dehumidifying the air flowing through the air conditioner, such that it is possible to operate it in the recirculating mode over longer periods of time in winter, thus reducing energy consumption. This has the major advantage, particularly in the winter, of supplying less fresh air to the passenger compartment that would then have to be heated. This shutter assembly, containing an adjustable shutter, is simple and inexpensive to make, resulting in an inexpensive and energy-efficient air conditioner when combined with the dehumidifier element. Particularly with electric vehicles that are run on batteries, this type of air conditioner can be one of the largest consumers of electricity, such that one that consumes less electricity is of particular importance. By switching between the adsorption mode and desorption mode, dehumidified air can be supplied over a long period of time to the passenger compartment, regardless of the people and/or objects therein that contribute to the condensation therein.

In an advantageous design of the air conditioner obtained with the invention, the first sub-channel opens into the passenger compartment, and the second sub-channel opens into the exterior. Consequently, when the shutter is in the first position, the air flowing through the dehumidifier can be dehumidified, i.e. dried, and returned to the passenger compartment, and when the shutter is in the second position, moisture is removed from the hygroscopic coating on the element, or its hygroscopic material, and discharged through the second sub-channel into the exterior.

It is understood that the shutter assembly can contain not only pivotal shutters, but also sliding shutters, depending on the space available in the motor vehicle and in the air conditioner.

The shutter assembly is ideally between the dehumidifier and the two sub-channels. This results in a compact construction, with the shutter placed on a wall separating the two sub-channels, such that by pivoting it over an angle of less than 45°, for example, the airflow through the dehumidifier can be diverted into the first or second sub-channel.

The dehumidifier can be placed downstream of a fan, and upstream of a filter element. This results in a split construction in which the dehumidifier and fan are outside the passenger compartment, and the filter is inside the passenger compartment. This structure can take specific installation spaces into account in the vehicle. The dehumidifier can also be placed downstream of the fan as well as the filter, such that the fan is between the dehumidifier and the filter. This can also result in a split construction.

This can free up installation space in the dashboard that can then be populated with other components such as display elements.

There can also be two dehumidifiers and two first and second sub-channels. In this case, the two first sub-channels and dehumidifiers lead to the passenger compartment, and the two second sub-channels lead to the exterior, i.e. the environment. With two dehumidifiers, a redundant system is obtained which can be operated for a long time in the recirculation mode, even in winter, and even if one of the dehumidifiers fails. If, for example, there is a lot of humidity in the passenger compartment, the two dehumidifiers can reduce the condensation level more quickly. The first dehumidifier can also function as the primary component, and the second as a secondary component, which is only activated when necessary.

The air conditioner obtained with the invention preferably has a control unit connected to the at least one dehumidifier and the shutter assembly that provides electricity to the element in the dehumidifier, thus heating it and switching it to the desorption mode when the shutter is in the second position. Electricity is provided to the element, thus heating it, only when the shutter is in its second position, to dehumidify the hygroscopic element. In the normal operating mode, i.e. the adsorption mode, in which the shutter is in the first position, such that air flowing over the hygroscopic element is dehumidified, the element requires no electricity, thus conserving energy, which is a major advantage with electric vehicles in particular.

The first sub-channel preferably has a larger cross section than the second in the air conditioner obtained with the invention. The advantage with this is that in the normal, recirculating mode, in which the shutter is in the first position, there is a larger flow cross section available, which generates less noise. Once the element is switched to the desorption mode, in which it is heated, a smaller cross section in the second sub-channel is sufficient for discharging moisture.

There is a secondary fan in the second sub-channel. This secondary fan, which accelerates the removal of moisture when the dehumidifier is in the desorption mode, i.e. when the element is heated, can be smaller than the primary fan.

The present invention is also based on the general idea of creating a motor vehicle that has a passenger compartment and the air conditioner described above, which has the same advantages as those attributed to the air conditioner. These advantages include an effective and energy-efficient dehumidifying of an air flow with the dehumidifier and the shutter assembly therein, such that the passenger compartment can be heated in the recirculating mode, in particular in winter, in an extremely energy-efficient manner. Particular in cold conditions, excessive humidity in the passenger compartment can result in condensation accumulating on the windows, which can obscure vision and result in long-term damage. This can be effectively and inexpensively prevented with the vehicle obtained with the invention.

This vehicle is ideally an electric vehicle. It can also be a hybrid vehicle. In either case, the air conditioner obtained with the invention can be operated in the recirculating mode for long periods of time, even in winter, thus conserving electricity, because air recirculating through the air conditioner in this mode does not have to be heated as much as fresh air. This requires less electricity, thus increasing the travel range of an electric or hybrid vehicle.

Other important features and advantages of the invention can be derived from the dependent Numbered Paragraphs, drawings, and descriptions of the drawings.

It is understood that the features specified above and explained below can be used not only in the given combinations, but also in other combinations or in and of themselves, without abandoning the scope of protection for the invention. Components of a higher-order unit, device or system that are referred to separately can be separate components of this unit or integral parts or sections thereof, even if otherwise indicated in the drawings.

Preferred exemplary embodiments of the invention are shown in the drawings and shall be explained in greater detail below, in which the same reference symbols are used for identical, similar, or functionally identical components.

Therein, schematically,

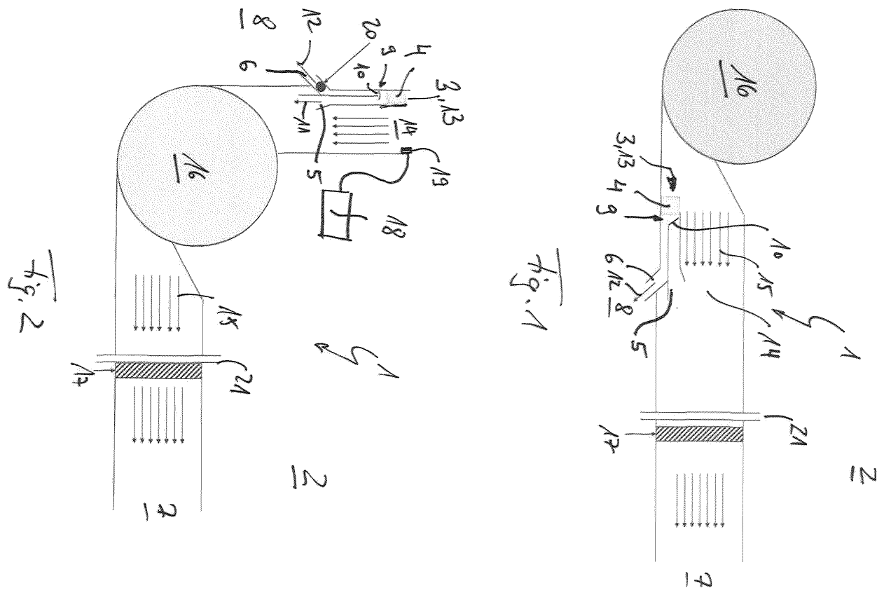

FIG. 1 shows a sectional view of a first embodiment of the air conditioner obtained with the invention, for a motor vehicle obtained with the invention,

FIG. 2 shows the same as that in FIG. 1, but with the dehumidifier upstream of the fan,

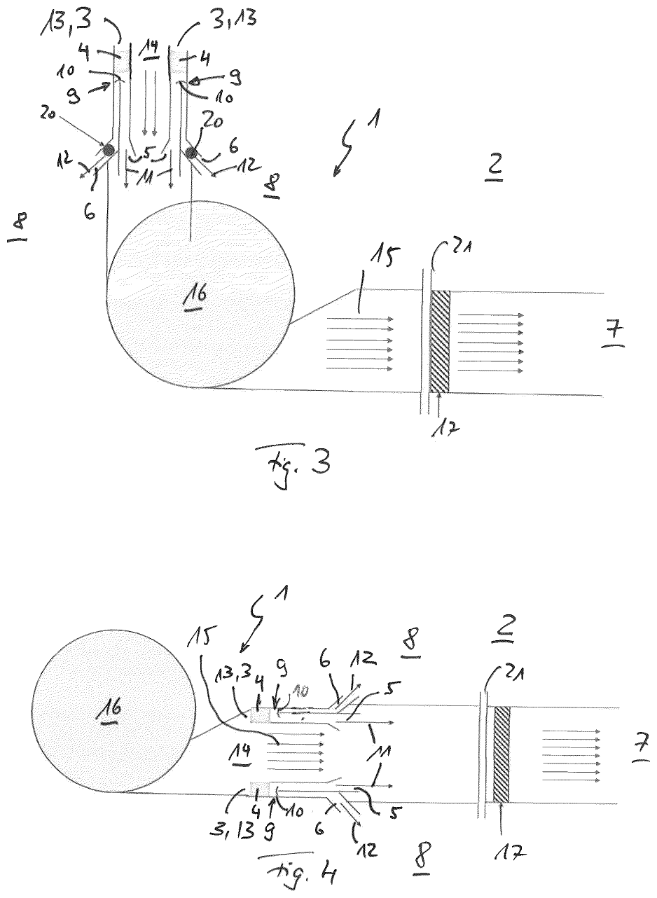

FIG. 3 shows the same as that in FIG. 2, but with two dehumidifiers,

FIG. 4 shows the same as that in FIG. 1, but also with two dehumidifiers.

The air conditioner 1 obtained with the invention shown in FIGS. 1-4, for an otherwise not shown motor vehicle 2, has a dehumidifier 4 in or on an airflow channel 3, which has a hygroscopic element that heats up when electricity is supplied thereto.

This type of hygroscopic element can thus be used as a heating element, which adsorbs moisture when it is not hot, i.e. an adsorption of water at the hygroscopic surface of the element takes place, and when the element is heated, it or its hygroscopic coating discharges this moisture. The hygroscopic element can be square, rectangular, cylindrical, oval, or irregular, and/or a PTC element.

The airflow channel 3 is divided into two sub-channels 5, 6 downstream of the dehumidifier 4, specifically a first sub-channel 5, which leads to a passenger compartment 7, and a second sub-channel 6, which leads to the exterior 8 of the vehicle 2. There is also a shutter assembly 9 with shutter 10 that can assume a first or second position, which, when it is in the first position, (see FIGS. 2 to 4), directs at least most of the airflow into the first sub-channel 5, and therefore the passenger compartment 7, and when it is in the second position, discharges at least most of the airflow through the dehumidifier 4 into the exterior 8 (see FIG. 1).

The terms, “shutter assembly 9” and “shutter 10” do not only refer to pivotal or rotating shutters, but also to sliders that can be slid between a first and second position to block the first or second sub-channel 5, 6. In general, the shutter 10, or slider, can also assume an intermediate position, such that air flows into both the first sub-channel 5, and thus into the passenger compartment 7, as well as the second sub-channel 6, and thus into the exterior 8.

The shutters 10 can be straight, as shown in FIG. 1, or curved, as shown in FIGS. 2 to 4.

FIGS. 1 to 4 also show that the airflow channel 3, in or on which the dehumidifier 4 is located, also forms a secondary channel 13, which has a significantly smaller cross section than the main channel 14, and is parallel thereto, in which air flows into the passenger compartment 7.

The shutter assembly 9 is preferably between the dehumidifier 4 and the two sub-channels 5, 6 in the airflow.

As shown in FIG. 1, as well as in FIG. 4, the dehumidifier 4 is downstream of a fan 16 and upstream of a filter 17. The dehumidifier 4 and the shutter assembly 9 can also be downstream of the fan 16 and the filter 17, as shown in FIGS. 2 and 3. These different possible positions of the dehumidifier 4 and shutter assembly 9, and the two sub-channels, can be determined by the specific installation spaces, or can take these individual installation spaces into account. The fan 16 can be a radial fan.

In the embodiment shown in FIGS. 1 and 2, the air conditioner 1 has only one dehumidifier 4, one shutter assembly 9, one first sub-channel 5, and one second sub-SUBSTITUTE channel 6. In the embodiment shown in FIGS. 3 and 4, there are two dehumidifiers 4, two first sub-channels 5, and two second sub-channels 6. The embodiment shown in FIGS. 3 and 4 thus forms a redundant system, which is extremely effective when both dehumidifiers 4 are functioning, and still effectively dehumidifies the air recirculating to the passenger compartment 7 when one of the dehumidifiers fails. The use of two such dehumidifiers 4 with two shutter assemblies 9 and two first and second sub-channels 5, 6 has the major advantage that the air sent or returned to the passenger compartment 7 is more quickly dehumidified when there is a great deal of moisture therein, such that the recirculation mode can still be used, even if it is very humid in the passenger compartment 7. One of the dehumidifiers 4 can be the primary dehumidifier, and the other can be used only when the humidity reaches peak levels.

In FIG. 1, the fan 16, dehumidifier 4, and both sub-channels 5, 6 are in front of a separating wall 21, which can be between the passenger compartment 7 and a space that is in front of it in the direction of travel. In this case, the fan 16, dehumidifier 4, shutter assembly 9, and both sub-channels 5, 6 are on one side of the wall 21, and the filter element 17 is on the other side, i.e. in the passenger compartment 7, for example. This allows for an effective split construction. The air conditioner 1 in FIG. 4 has a similar construction, but with two dehumidifiers 4, two shutter assemblies 9, and two first and second sub-channels 5, 6.

The air sent to the passenger compartment 7 can be filtered by the filter 17 shown in FIGS. 1-4. This can be a particle filter or a virus filter made of activated carbon, with which hydrocarbons can be filtered out, for example.

Both the first airflow 11, into the passenger compartment 7, and the second airflow 12, into the exterior 8, are indicated in FIGS. 2 to 4, although it should be clear that when the shutter 10 is in its first or second position, only the first airflow 11 or second airflow 12 is formed.

The section of the channel containing the dehumidifier 4, shutter assembly 9, and both sub-channels 5, 6 in the embodiment shown in FIGS. 2 and 3 is orthogonal to a channel section leading to the passenger compartment 7, such that the specifics of the installation space can be taken into account.

There can also be a control unit 18, which is only shown in FIG. 2 for purposes of clarity, which is connected to the at least one dehumidifier 4 and the at least one shutter assembly 9. This control unit 18 provides electricity to the hygroscopic element in the dehumidifier 4, thus heating it, such that its hygroscopic material, or hygroscopic coating, is switched to the desorption state when the shutter 10 is in its second position (see FIG. 1), in which the airflow in the airflow channel 3 is discharged, at least mostly, preferably entirely, from the motor vehicle 2 into the exterior 8. Activating the shutter 10, or providing electricity to the dehumidifier 4, or the element therein, depends on the humidity level, which can be detected by a moisture sensor 19, which is also connected to the control unit 18. In this case, the dehumidifier 4 is heated, and the shutter 10 is moved to its second position if the sensor 19 detects that a predefined humidity level has been reached or exceeded. Consequently, the dehumidifier 4 and a first airflow 11 into or returned to the passenger compartment 7 can be controlled automatically, resulting in significantly better air conditioning.

FIGS. 1 to 4 also show that the secondary channel 13, containing the dehumidifier 4, has a much smaller cross section than the main channel 14, which has the major advantage that in the normal operating mode, in which it is unnecessary to dehumidify the air recirculated to the passenger compartment 7, a larger cross section is available, which generates less noise. If the moisture sensor 19 detects excessive humidity, the control unit 18 moves the shutter 10 to its second position and activates the element, heating it such that it is in the desorption state, i.e. such that it discharges moisture. This only requires the smaller cross section of the airflow channel 3, or the secondary channel 13, and the second sub-channel 6.

To further dehumidify the air flowing through the dehumidifier 4, there can also be a secondary fan 20 in the second sub-channel 6, and if there are two second sub-channels 6, as is the case in FIGS. 3 and 4, there can also be two secondary fans 20. It is possible to air condition a vehicle 2, which can be an electric vehicle or hybrid vehicle, with the air conditioner 1 obtained with the invention for a longer period of time in the energy-saving recirculation mode, in particular in winter, such that fresh air does not need to be obtained from the exterior, which must then be heated.

The specification can be readily understood with reference to the following Numbered Paragraphs:

Numbered Paragraph 1. An air conditioner (1) for a motor vehicle (2) that has a dehumidifier (4) in or on a flow channel (3), which contains a hygroscopic element, wherein
the flow channel (3) is divided into two sub-channels (5, 6) downstream of the dehumidifier (4),
there is a shutter assembly (9) with a shutter (10) that can be pivoted between at least a first and second position, and
when the shutter (10) is in the first position, at least most of the air flowing through the dehumidifier is conducted into the first sub-channel (5), and in the second position, at least most of the air flowing through the dehumidifier is conducted into the second sub-channel (6).

Numbered Paragraph 2. The air conditioner (1) according to Numbered Paragraph 1, characterized in that the hygroscopic element in the dehumidifier (4) can be heated.

Numbered Paragraph 3. The air conditioner (1) according to Numbered Paragraph 1, characterized in that the first sub-channel (5) opens into a passenger compartment (7), and the second sub-channel (6) opens into the exterior (8).

Numbered Paragraph 4. The air conditioner (1) according to Numbered Paragraph 1 or 2, characterized in that the shutter assembly (9) is between the dehumidifier (4) and the two sub-channels (5, 6).

Numbered Paragraph 5. The air conditioner (1) according to any of the preceding Numbered Paragraphs, characterized in that the dehumidifier (4) is downstream of a fan (16).

Numbered Paragraph 6. The air conditioner (1) according to any of the Numbered Paragraphs 1 to 3, characterized in that the dehumidifier (4) is upstream of a fan (16) and upstream of a filter (17).

Numbered Paragraph 7. The air conditioner (1) according to any of the preceding Numbered Paragraphs, characterized in that there are two dehumidifiers (4) and two first and second sub-channels (5, 6).

Numbered Paragraph 8. The air conditioner (1) according to any of the preceding Numbered Paragraphs, characterized in that there is a control unit (18) connected to the at least one dehumidifier (4) and the shutter assembly (9).

Numbered Paragraph 9. The air conditioner (1) according to Numbered Paragraph 7, characterized in that the control unit (18) provides electricity to the element in the dehumidifier (4), heating it and therefore switching it to a desorption mode, when the shutter (10) is in its second position.

Numbered Paragraph 10. The air conditioner (1) according to any of the preceding Numbered Paragraphs, characterized in that the first sub-channel (5) has a larger cross section than the second sub-channel (6).

Numbered Paragraph 11. The air conditioner (1) according to any of the preceding Numbered Paragraphs, characterized in that there is a secondary fan (20) in the second sub-channel (6).

Numbered Paragraph 12. A motor vehicle (2) with a passenger compartment (7) and an air conditioner (1) according to any of the preceding Numbered Paragraphs.

Numbered Paragraph 13. The motor vehicle (2) according to Numbered Paragraph 11, characterized in that the motor vehicle (2) is an electric vehicle.

### List of Reference Symbols

1 air conditioner
2 motor vehicle
3 flow channel
4 dehumidifier
5 first sub-channel
6 second sub-channel
7 passenger compartment
8 exterior/environment
9 shutter assembly
10 shutter
11 airflow in first sub-channel
12 airflow in second sub-channel
13 secondary channel
14 main channel
15 flow direction
16 fan
17 filter
18 control unit
19 humidity sensor
20 secondary fan
21 separating wall

1-13. (canceled)

14. An air conditioner for a motor vehicle comprising a dehumidifier in or on a flow channel, the dehumidifier comprises a hygroscopic element, wherein the flow channel is divided into two sub-channels downstream of the dehumidifier;
further comprising a shutter assembly with a shutter that is configured to be pivoted between at least a first position and a second position,
wherein when the shutter is in the first position, at least most of the air flowing through the dehumidifier is conducted into the first sub-channel, and when the shutter is in the second position, at least most of the air flowing through the dehumidifier is conducted into the second sub-channel.

15. The air conditioner according to claim 14, wherein the hygroscopic element in the dehumidifier is configured to be heated.

16. The air conditioner according to claim 14, wherein the first sub-channel opens into a passenger compartment, and the second sub-channel opens into an exterior of a vehicle that includes the passenger compartment.

17. The air conditioner according to claim 14, wherein the shutter assembly is between the dehumidifier and the first and second sub-channels.

18. The air conditioner according to claim 14, wherein the dehumidifier is downstream of a fan.

19. The air conditioner according to claim 14, wherein the dehumidifier is upstream of a fan and upstream of a filter.

20. The air conditioner according to claim 14, wherein the dehumidifier is two dehumidifiers that each include first and second sub-channels.

21. The air conditioner according to claim 14, further comprising a control unit connected to the at least one dehumidifier and the shutter assembly.

22. The air conditioner according to claim 20, wherein the control unit is configured to provide electricity to an element in each of the two dehumidifiers, wherein electricity flow to the element heats the element, wherein heating the element and therefore switching the two dehumidifiers to a desorption mode, when the shutter is in the second position.

23. The air conditioner according to claim 14, wherein the first sub-channel has a larger cross section than the second sub-channel.

24. The air conditioner according to claim 14, further comprising a secondary fan in the second sub-channel.

25. A motor vehicle with a passenger compartment and an air conditioner according to claim 14.

26. The motor vehicle according to claim 24, wherein the motor vehicle is an electric vehicle.
